(19) United States
(12) Patent Application Publication
(10) Pub. No.: US 2002/0065635 A1
(43) Pub. Date: May 30, 2002

(54) Virtual reality room

(76) Inventors: Joseph Lei, Los Angeles, CA (US); Philip Ra, Los Angeles, CA (US); Ronald Lai, Los Angeles, CA (US)

Correspondence Address: LIU & LIU LLP, 811 WEST SEVENTH STREET, SUITE 1100, LOS ANGELES, CA, 90017, US

(21) Appl. No.: 09/726,958

(22) Filed: Nov. 30, 2000

Related U.S. Application Data
(60) Provisional application No. 60/168,393, filed on Dec. 2, 1999.
(60) Provisional application No. 60/202,941, filed on May 9, 2000.

(51) Int. Cl. G06F 17/50

(52) U.S. Cl. 703/1

(57) ABSTRACT

The present invention is directed to an improved system and method for enabling the selection and configuration of furniture/room layout for temporary housing/residencies, which overcomes some of the drawbacks in the prior art systems and methods. For purposes of illustrating the inventive concept, the present invention is described using the example of university housing/residency services, more particularly, in the Internet environment. In one embodiment of the present invention, students of universities have the freedom to design the layout and finishes of their future housing rooms before they set foot on campus. Users can design their room into a virtual reality model via a service provider's Internet web site. In there they can change the room finishes, move the furniture into different configurations, and incorporate appliances and personal items into the room design. Users can also take a tour of their virtual room through pre-defined viewpoints or a free-form walk through. Once the rooms are designed, the service provider takes the design and builds it. Therefore on the move-in day, the user opens the door to a room designed by themselves.

### BACKGROUND OF THE INVENTION

1. Field of the Invention

The present invention relates to customization of space layout and a graphical user interface related thereto.

2. Description of Related Art

Spaces such as hotel rooms, dormitory rooms, offices, countryside lodges, camps, hospital rooms, and apartments are sometimes occupied by tenants for an extended period beyond a short stay such that the tenants tend to be more sensitive, particularly about the spaces. At some locations, there are a number of standardized spaces (both in size and/or shape) available to tenants. Some are available in mass quantity. These spaces are not exactly customized to fit tenants' personal taste and/or requirements (i.e., color, finishes, layout, items in the room, etc.). For an extended stay, a tenant may wish for a more pleasant environment customized to the taste of the individual.

University housing conditions have long been an issue when speaking of on-campus living. Conversations regarding university housing often contain many misunderstandings and complaints from students and parents. Although the price of university housing has risen recently, the revenues that schools have generated usually are not adequate to maintain the quality the students expect of residence hall rooms.

Many freshmen describe the pressure and anxiety they experience on their move-in day as an unpleasant experience. It is often due to not knowing what to expect from these housing units. Many of these students also are not aware of the restrictions and/or the time it takes to modify their rooms—if permitted by the university. They are dissatisfied with the “plain vanilla box” they are given and endeavor to personalize and make the room home during the rest of their stay, which may last for one or more years. However, due to many rules and policies, the amount of “personal touch” has been limited in the past.

It is therefore desirable to provide for customization and configuration of a living or working space that overcomes the above-mentioned drawbacks.

### SUMMARY OF THE INVENTION

The present invention is directed to an improved system and method for enabling the selection and configuration of layout for temporary spaces, and a service for implementing the configuration. It overcomes some of the drawbacks in the prior art systems and methods.

The term “temporary space,” in the present application, means a place where a user's intent is not to stay indefinitely and which may be owned or leased (whether for monetary or other considerations) by the user. However, the user would stay long enough to have a desire to personalize the space and to make it worthwhile to invest in customizing the space. In some situations, the user may not actually see the physical space before taking possession of it, although he would visualize it through a computer display system.

In one embodiment of the present invention, students of universities have the freedom to design the layout and finishes of their future housing rooms before they set foot on campus. Users can design their room into a virtual reality model via a service provider's Internet web site. In there they can change the room finishes, move the furniture into different configurations, and incorporate appliances and personal items into the room design. Users can also take a tour of their virtual room through pre-defined viewpoints or a free-form walk through. The web site also incorporates a chat line for users to talk with prospective roommates to design their rooms together. Once the rooms are designed, the service provider takes the design and builds it. Therefore on the move-in day, the user opens the door to a room designed by themselves, reflecting their individuality, identical to the room previewed on the website.

Through extensive coordination and evaluation with each university, all design configuration options and work to be performed by the service provider to the residence hall rooms are university-approved (12); this eliminates university's concerns regarding damage to rooms or violation of safety codes, and promotes consistency of the design configurations with respect to the university's guidelines, culture and character. Physical measurements, such as room and furniture dimensions, are taken by the service provider to predetermine the physical attributes of the room and improvements to be added to the room, so that the users do not need to make measurements to define the space and improvements when customizing the room. In addition, all color choices for wall paint, rugs, blinds, etc. are to be approved by the university at this stage. Since students pay the remodeling fee, the cost paid by the university for cosmetic maintenance of the residence halls drops dramatically. The present invention also appeals to universities because it offers improved customer service.

The above, as well as additional objects, features, and advantages of the present invention will become apparent in the following detailed written description.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings.

FIG. 1 is a flowchart illustrating an overview of the invention.

FIGS. 2 and 3 are flowcharts illustrating the process by which the user selections the room configuration through computer modeling.

FIG. 4 is a flowchart illustrating the process by which the service provider remodels and refinishes the room.

FIG. 5 is a schematic representation of one embodiment of a computer network through which the auctioning process and system of the present invention may be implemented.

FIG. 6 is a schematic representation of one embodiment of a computer system that facilitates the auctioning process of the present invention.

### DETAILED DESCRIPTION OF THE PREFERRED EMBODIMENT

This invention is described in a preferred embodiment in the following description with reference to the drawings. While this invention is described in terms of the best mode for achieving this invention's objectives, it will be appreciated by those skilled in the art that variations may be accomplished in view of these teachings without deviating from the spirit or scope of the invention. This description is made for the purpose of illustrating the general principles of the invention and should not be taken in a limiting sense. The scope of the invention is best determined by reference to the appended claims.

The present invention relates to a new kind of e-service that has been created using tools developed by a service provider for three-dimensional (3-D) web-based visualization, for use on the Internet. By way of example and not limitation, the service aspect of the present invention is discussed in reference to university housing/residency services.

The present invention relates to a temporary space that is worthwhile to personalize. This service is not provided for any uninformed stranger. Neither is the service so broad as to allow the user to merely visualize a room. Contrasting with prior art, the service of the present invention does not provide modular spaces that can always be reconfigured. Also, although prior art addresses designing spaces for ergonomic reasons, this service directly incorporates individual input for “personal touch” customization according to the user's comfort and taste. The service provider seeks to introduce the freedom and individual creativity of interior design to the universities' housing residents. Prior to moving in, students can view their future room in its current condition through the service provider's 3-D engine via the Internet.

Services for Defining Temporary Housing Layout

The present invention is directed to a service that facilitates selecting and configuring furniture/room layouts for temporary housing/residencies. To facilitate an understanding of the principles and features of the present invention, they are explained herein below with reference to its deployments and implementations in illustrative embodiments directed to university housing. By way of example and not limitation, the present invention is described herein below in reference to examples of deployments and implementations in an information exchange environment and, more particularly, in the Internet environment.

The present invention can find utility in a variety of implementations without departing from the scope and spirit of the invention, as will be apparent from an understanding of the principles that underlie the invention. It is understood that the room layout configuring concept of the present invention may be applied to configuring spaces of other nature, whether in a information network environment or otherwise.

Information Exchange Network

The room layout selection and configuration aspect of the present invention will be described below in connection with the example of conducting transactions over a distributed computer network. The room layout selection and configuration platform may involve, without limitation, distributed information exchange networks such as public and private computer networks (e.g., Internet, Intranet, WAN, LAN, etc.), value-added networks, communications networks (e.g., wired or wireless networks), broadcast networks, and a homogeneous or heterogeneous combination of such networks. As will be appreciated by those skilled in the art, the networks include both hardware and software and can be viewed as either, or both, according to which description is most helpful for a particular purpose. For example, the network can be described as a set of hardware nodes that can be interconnected by a communications facility, or alternatively, as the communications facility, or alternatively, as the communications facility itself with or without the nodes. It will be further appreciated that the line between hardware and software is not always sharp, it being understood by those skilled in the art that such networks and communications facility involve both software and hardware aspects.

A method or process is here, and generally, conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Useful devices for performing the operations of the present invention include, but is not limited to, general or specific purpose digital processing and/or computing devices, which devices may be standalone devices or part of a larger system. The devices may be selectively activated or reconfigured by a program, routine and/or a sequence of instructions and/or logic stored in the devices. In short, use of the methods described and suggested herein is not limited to a particular processing configuration. Prior to discussing details of the inventive aspects of the present invention, it is helpful to discuss one example of a network environment in which the present invention may be implemented.

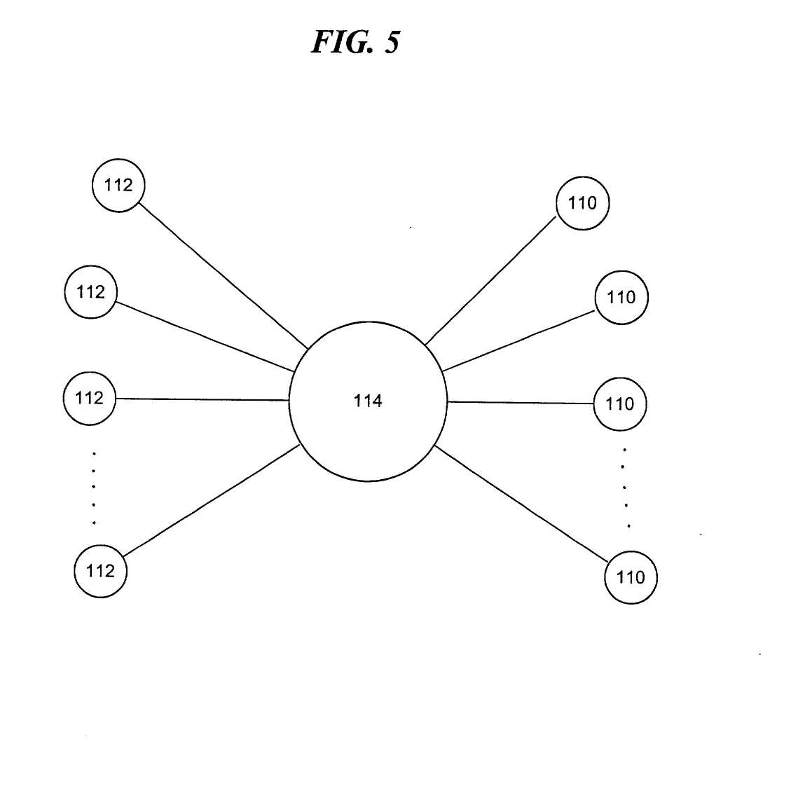

The Internet is an example of an information exchange network including a computer network in which the present invention may be implemented, as illustrated schematically in FIG. 5. Many servers 110 are connected to many clients 112 via Internet network 114, which comprises a large number of connected information networks that act as a coordinated whole. Details of various hardware and software components comprising the Internet network 114 are not shown (such as servers, routers, gateways, etc.), as they are well known in the art. Further, it is understood that access to the Internet by the servers 110 and clients 112 may be via suitable transmission medium, such as coaxial cable, telephone wire, wireless RF links, or the like. Communication between the servers 110 and the clients 112 takes place by means of an established protocol. As will be noted below, the auctioning system of the present invention may be configured in or as one of the servers 110, which may be accessed by buyers and service providers via clients 112.

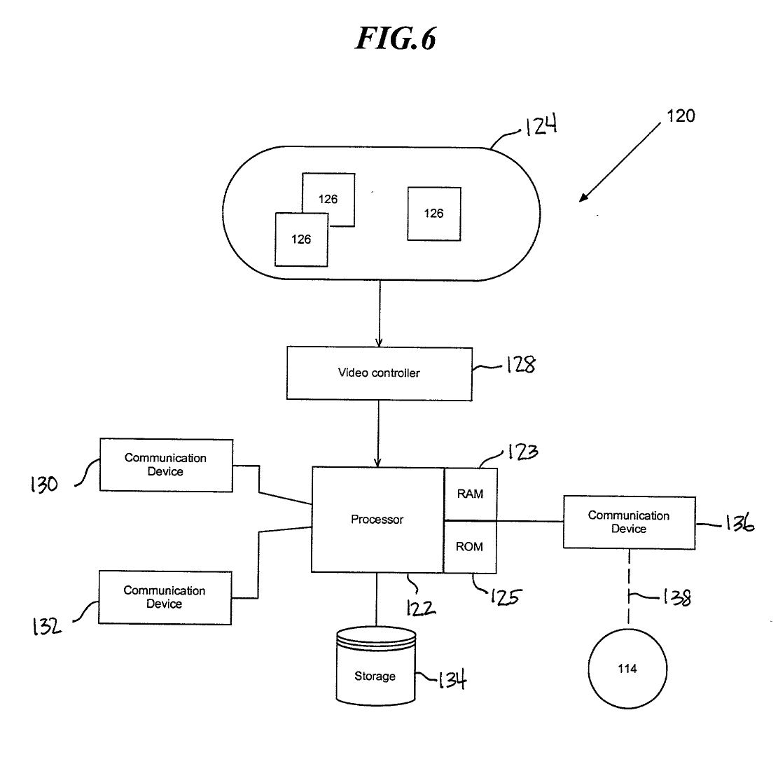

Turning now to FIG. 6, there is schematically illustrated one embodiment of a computer system 120 which may be configured as the client 112 for navigating the Internet. The computer system 120 communicates with the Internet network 114. The computer system 120 includes a processor 122, internal random-access memory (“RAM”) 123 and read-only memory (“ROM”) 125, and a data bus architecture for coupling the processor 122 to various internal and external components. The computer system 120 further includes a communication device 136, which, in turn, is coupled to a communication channel 138 for effecting communication with the Internet network 114. A mass storage device 134, such as a hard disk drive or floppy disk drive or CDROM drive, is coupled to the processor 122 for storing utility and application software (including a suitable web browser for navigating the Internet) and other data. The application software is executed or performed by the processor 122.

Input devices controlled by the user are also coupled to the processor 122, including a cursor positioning device 130 and a keyboard 132 in accordance with the present invention. The cursor-positioning device 130 is representative of any number of input devices that produce signals corresponding to a cursor location on the display 124, and may include by way of example, a mouse, a trackball, an electronic pen, or a touch-pad, which may be an integral part of the keyboard 132. A display 124 is coupled to the processor 122 through a video controller 128. The video controller 128 coordinates the presentation of information on the display 124 in one or more windows 126. Generally, the windows 126 are scalable, thus permitting a user to define the size and location of a particular window 126 on the display 124.

The server 110 could also have similar components as the computer system 120 depicted in FIG. 6. The program configuration of the client 112 and server 110 would be apparent given the disclosure of the desired functions of the present invention to be implemented in the client 112 and server 110 disclosed herein below. Basic online processes are well known in the art.

Information networks provide the environment to implement room layout selection and configuration. Using the Internet, for example, allows the user to access the service available. The functionalities in accordance with the present invention may be implemented in a server (such as server 110) and/or partly in a client (such as client 112). The user may access the functionalities of the present invention via a client 112 and/or a server 110. Relevant information to support the process of the present invention may be stored in volatile and non-volatile storage devices found in the client 112 and/or server 110, or elsewhere in the system.

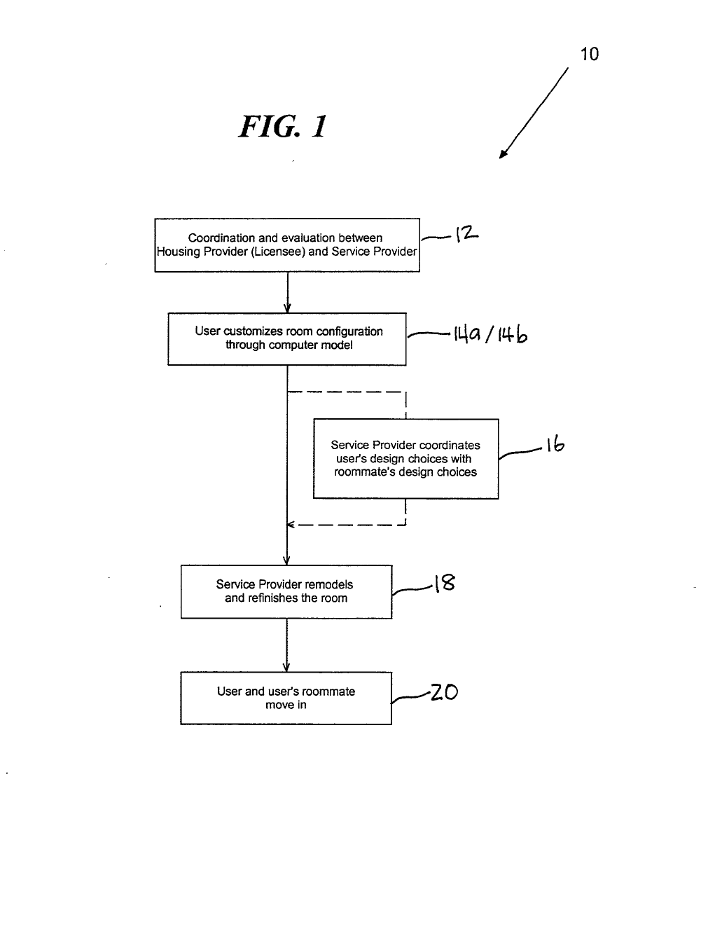

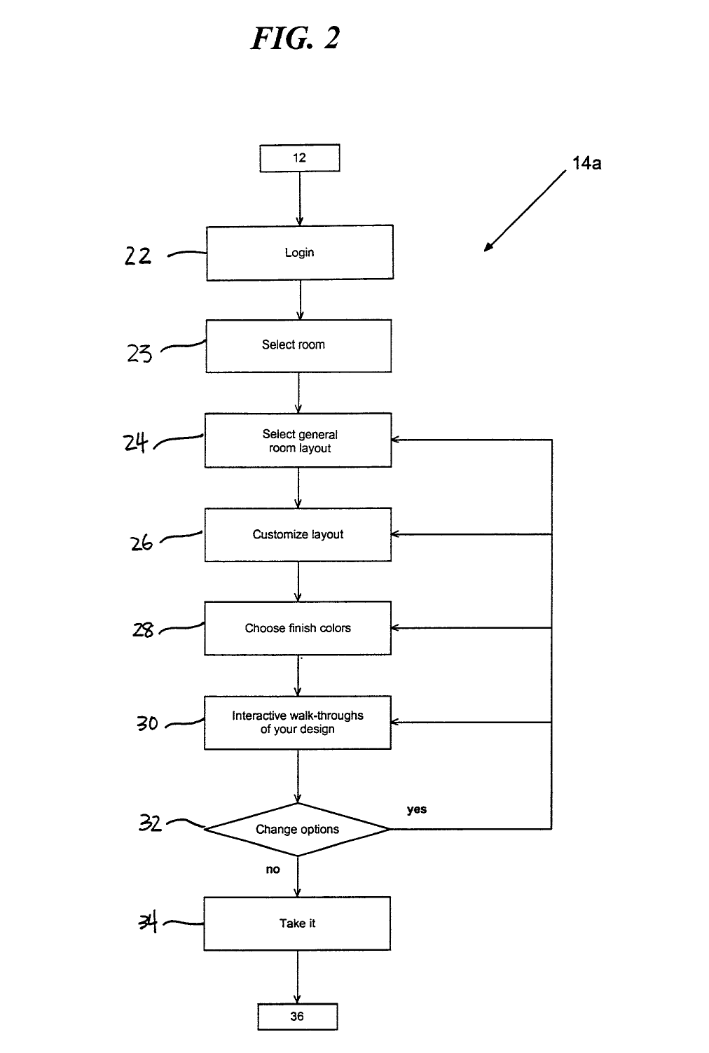

FIG. 1 illustrates the overall process of the service in accordance with one embodiment the present invention. It offers students (i.e., tenants or users) the opportunity to express their creativity and individuality through their room and to create a harmonious space where they can study and relax. First, coordination between the university (i.e., housing provider) and the service provider (12) occurs. After the user selects his room configuration through computer modeling (14a/14b), an optional step includes the service provider coordinating the user's design choices with the roommate's design choices (16). Then, the service provider remodels and refinishes the room (18) in preparation for the user to move in (20). FIGS. 2-4 further illustrate details of the high level process shown in FIG. 1.

In accordance with an aspect of the present invention, through extensive coordination and evaluation with each university, all design configuration options and work to be performed by the service provider to the residence hall rooms are university-approved (12); this eliminates university's concerns regarding damage to rooms or violation of safety codes, and promotes consistency of the design configurations with respect to the university's pre-established policies, regulations, guidelines, culture and character. Physical measurements, such as room and furniture dimensions, are taken by the service provider to predetermine the physical attributes (including floor plan, physical dimensions, physical characteristics) of the room and improvements to be added to the room, so that the users do not need to make measurements to define the space and improvements when customizing the room. In addition, all color choices for wall paint, rugs, blinds, etc. are to be approved by the university at this stage. For example, for a university dormitory having 100 rooms, the service provider would predetermine the physical attributes of the 100 rooms, and propose design and improvement options (including without limitation, general layout, design, furnishing items, color scheme, etc.).

After evaluation of the terms and conditions, and proposed improvement options by both the university and the service provider, the service provider implements university approved design options and constraints into their specific business operation plan as well as into their computer modeling system, whereby the user selects the room configuration (14a/14b). This service includes the construction and maintenance of a web site unique to universities. The web site is also linked to a database (e.g., at the service provider server) where all student information and activity can be stored and recalled. A computer program (developed using, without limitation, Java, C and/or C++) with 2-D or 3-D modeling software and graphical user interface provides an interactive environment for modeling a virtual room. The 3-D model would use VRML (virtual reality markup language) as its core for an animated interface. Other software such as Cult3D (by Cycore), Shout 3D (by Eyematic), and Flash would also be used. The web site is programmed with facilities whereby universities can change finish options for students and control the “design parameters” to be followed by the student. The web site also includes a design wizard, which is in essence a digital architect/interior designer. All colors, characters, and animations can be modified to suit universities. In contrast with prior art that also allows computer modeling, this service relates to exact measurements for rooms that exist. The 3-D models have been created with the possible options prior to the user even inputting any information into the system/server.

FIG. 2 illustrates this process of customizing with the provided options. After logging on (22) the service provider's web site with the required personal information, the user identifies the room that the user selected or rented (23) under a separate arrangement with the university.

Since the service provider has already predetermined the physical attributes of the particular room chosen by the user, the user does not need to obtain and enter any information concerning the physical attributes. The user is presented with an image of the floor plan of the room (either in 2-D or 3-D). The user selects the general room layout (24). This may include general positioning of major pieces of furniture in different configurations or choosing a certain side of the room (for roommates sharing a room). Several predefined options (and preapproved by the university) for the general room configuration may be proposed to the user, who selects one of the predefined options that she prefers. Then, the user customizes details of the layout (26), or mix-and-matches furnishings. Another step includes choosing finish colors (28). Once the selections have been made, the user can experience interactive walk-throughs of his design (30).

The system may be configured to render a 2-D or 3-D image of the layout of the room as finished with the selected improvement options. If the user desires to make changes to defining the room layout 24, to customizing the layout 26, or to choosing the finish colors 28, then he can either select “back” or select specifically which of the steps to change. The step-by-step design on cue by user contrasts with prior art that only allows the user to select from templates only. As a result of the coordination between the university and the service provider prior to introducing this service to the user, the furniture is set, or pre-selected (i.e., dimensions). When the user is satisfied with the overall layout of the room, he can choose to take it (34).

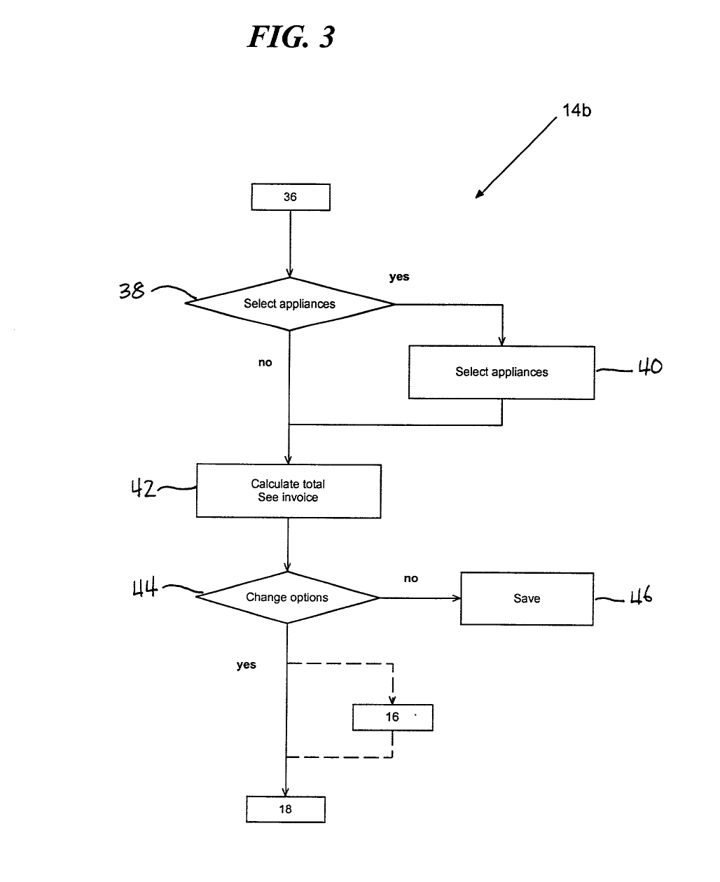

FIG. 3 continues the process (36) of selecting the room configuration through computer modeling. The service provider provides a selection of accessory appliance items (38) such as alarm clocks, TV sets, and lamps for purchase by the user (40). The service could eventually extend to include furniture, computers, and other accessory items. After this choice is made, the invoice is provided with the calculated total (42). If the user decides not to purchase the design (44), then he can save it (46) and return to the site at a later time during which the saved info can be retrieved. In addition, the user can save his progress at any time during the selection process regardless of whether a purchase is made. If the user is finished with the design, then he can proceed and purchase it. The service provider may request a deposit or full payment for the services prior to rendering the services.

For situations involving roommates for the same room, a chat line and e-mail are integrated into the service provider's software to allow the user to communicate with his prospective roommate to discuss the design of the room. They can work on the design together, communicating through the chat line, or design by themselves, sending suggestions and messages to each other through e-mail. Since roommates can chat on the Internet, roommates/users can interact with their prospective roommate at an earlier date, thereby potentially reducing the amount of roommate conflicts that would result in room changes and reassignment or dissatisfaction with room conditions. The system can provide the second user (i.e., the roommate who is second in time to log onto the system to make improvement choices) the improvement options selected by the first user. The second user may agree with the first user; or the second user communicates with the first user to come to agreement of options acceptable to both users; or if an agreement cannot be reached, the second user may make her own selection of the improvement options and leave it to the system to arbitrate and coordinate the final improvement options. An alternate solution or additional option could be putting accent walls and/or smaller individual items (e.g., rugs, furniture) on each side of the room (i.e., essentially avoiding common/shared items, and separating the room into independent half from the improvement option perspective).

As shown in FIG. 3, an optional step before the actual remodeling and refinishing includes the service provider arbitrating and coordinating the user's design choices with her roommate's design choices (16). This step is optional because it can be bypassed if both the user and the roommate coordinate on certain decisions via methods mentioned above, then the selections that have been agreed upon can be input separately without having to worry about design conflicts later on. On the other hand, if the user and roommate each input selections online separately and independently without conferring with each other or an agreement cannot be reached with respect to improvement options, then the service provider resolves design conflicts based on one or more pre-established criteria, such as priority in timing, the type of improvement options, etc.

For example, if a conflict arises in the room designs, the following actions may be taken:

(a) The service provider may contact (e.g., via email) both roommates and make them aware of the discrepancies between the two designs. The service provider may continue to ask both roommates to consult each other and redesign their rooms until the roommates agree upon a single design or when the pre-established design deadline expires, whichever comes first.

(b) If the design deadline has passed without a single agreed-upon design by the two roommates, the service provider may enforce a priority policy, such as all orders are processed on a first pay, first serve basis. The first roommate to pay for the improvement options may, for example, choose the wall paint and window blind color, and the other roommate will have the choice of the carpet.

(c) Users may also agree on choosing a room with accent walls and smaller individual items (e.g., rugs, furniture) on each side of the room.

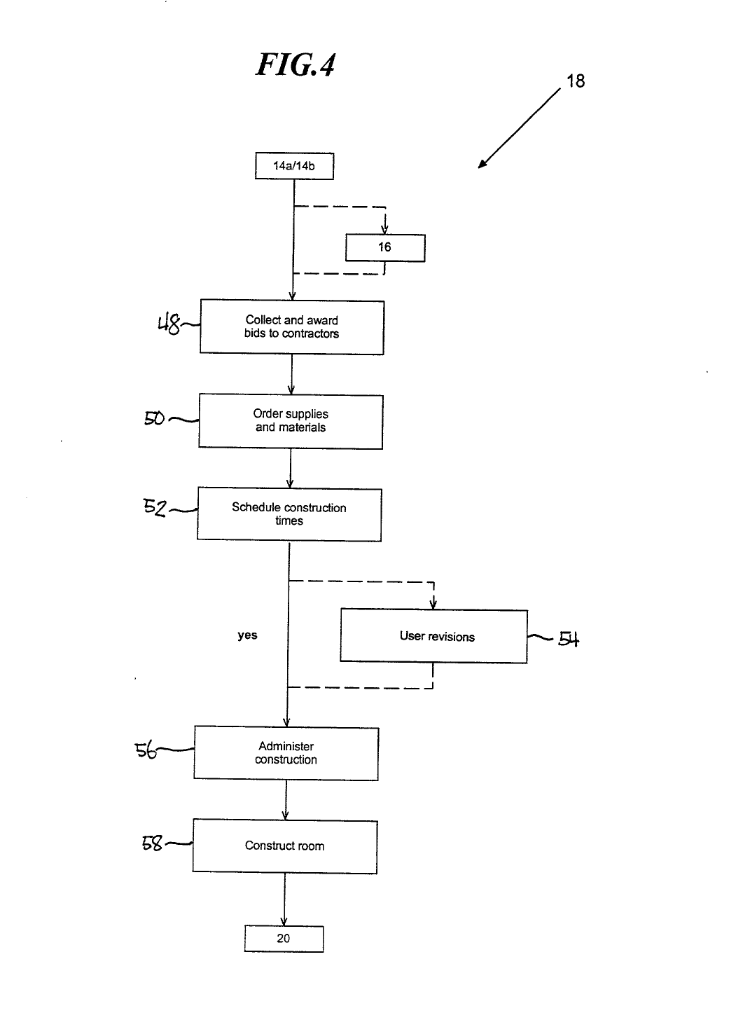

After receiving the user's final design (or a final design agreed by the roommates or coordinated by the service provider), the service provider remodels and refinishes the user/student's room according to his design (18). Since all this work is done by the service provider prior to the users/students moving in, there is little for the students to do apart from clicking their way to their designed room. This is illustrated in greater detail in the flowcharts in FIG. 4. Once the design is set to the user's satisfaction, the click of a button sends the completed selections to the service provider's server. The term “service provider” includes all employees, even contractors from whom bids are collected and awarded (48). The service provider orders supplies and materials (50) and schedules construction times (52). User revisions to the design (54) are accepted up to a certain time before the actual construction takes place. The service provider then administers construction (58). The service provider's crew of contractors paints the walls using the color the student selected, installs the rug and blinds the student selected, and 5 rearranges the furniture. On move-in day, the students will open the door to their new custom-finished room (20), just as they have designed it. If additional appliances have been purchased online, then the service provider will arrange for those to be picked up on the day of move-in.

The present invention provides universities with a powerful tool to improve customer service and gives users (students and parents) better value for their money. This service allows universities to enhance the students' university living experience and reassure parents that their children are well cared for in school. An advantage of implementing this service includes the dramatic drop of the cost paid by the university for cosmetic maintenance of the residence halls since students pay the remodeling fee, which they may not mind because they are getting value for their money.

The process and system of the present invention has been described above in terms of functional modules with reference to the block/flow diagrams illustrated. It is understood that unless otherwise stated to the contrary herein, one or more functions may be integrated in a single physical device or a software module in a software product, or a function may be implemented in separate physical devices or software modules, without departing from the scope and spirit of the present invention.

It is appreciated that detailed discussion of the actual implementation of each module is not necessary for an enabling understanding of the invention. The actual implementation is well within the routine skill of a programmer and system engineer, given the disclosure herein of the system attributes, functionality and inter-relationship of the various functional modules in the system. A person skilled in the art, applying ordinary skill can practice the present invention without undue experimentation.

While the invention has been described with respect to the described embodiments in accordance therewith, it will be apparent to those skilled in the art that various modifications and improvements may be made without departing from the scope and spirit of the invention. In the example discussed above, the service provider is described to be an entity separate from the university. However, it is within the scope and spirit of the present invention that the service provider may be part of the university, for example as a department of the university. Alternatively, the services and functions of the service provider may be outsourced. Further, some of the services and functions of the service provider described above may be handled by the university and some handled by a different entity. Thus, reference to service provide include all entity involved in providing the functions and features of the services in accordance with the present in invention. Although the present invention has been described with the example of the university dormitories, the service provided in this invention can be implemented into other “temporary” room situations. Other possibilities of rooms that can be selected and configured include workstations, vacation homes or lodges, office cubicles or offices, and apartments. Also, any other type of room, possibly rented, that users will want to personalize can be applied to the service provided as described in the present invention. Accordingly, it is to be understood that the invention is not to be limited by the specific illustrated embodiments, but only by the scope of the appended claims.

We claim:

1. An interactive process for facilitating customization of the layout of a space to be occupied by a user, comprising the steps of:
a service provider predetermining the physical attributes of the space independent of the user's input;
the user identifying to the service provider the space selected to be occupied by the user;
the service provider displaying to the user an image representing the floor plan of the space;
the service provider making available to the user different improvement options that user may select to configure the layout of the space;
the user selecting the improvement options for the space;
the service provider displaying to the user an image representing the space implemented with the improvement options;
the user engaging the service provider to remodel the space in accordance with the selected improvement options; and
the service provider remodeling the space in accordance with the selected improvement options.

2. A process as in claim 1, wherein the space is managed by a third party who makes the space available to the user, wherein the process further comprising the step of the service provider obtaining permission from the third party to provide customization services to the user.

3. A process as in claim 2, wherein the third party pre-establishes rules with respect to permissible improvement options for the space which are to be made available to the user.

4. A process as in claim 1, wherein the user may revise the improvement options upon viewing the image representing the space implemented with the improvement options.

5. A process as in claim 1, wherein the service provider displays the images by way of a 2-D or 3-D graphical user interface.

6. A process as in claim 1, wherein there is at least a second user sharing the space, wherein the process further comprises the step of coordinating the improvement options selected by the two users.

7. A process as in claim 6, wherein the process allows two or more users an opportunity to agree on the improvement options for the space.

8. A process as in claim 7, wherein the second user independently interacts with the service provider to select the improvement options for the space, wherein the service provider coordinates the improvement options independently selected by two or more users in accordance with a priority policy.

9. A process as in claim 1, wherein the service provider predetermines the physical attributes, including at least one of:
physical dimensions;
floor plan; and
physical characteristic.

10. A process as in claim 9, wherein the improvement options includes at least one of:
general space layout;
color scheme;
improvement items;
design.

11. A process as in claim 10, wherein the space includes at least one of:
dormitory room;
apartment;
cottage; and
office.

12. A process as in claim 1, wherein the interaction of the user and the service provider is via a distributed information exchange network.

13. A process as in claim 12, wherein the distributed information exchange network is the Internet.

14. An interactive system for facilitating customization of the layout of a space to be occupied by a user, comprising:
means for storing physical attributes of the space predetermined by the service provider independent of the user's input; and
processing means for:
receiving input concerning the space selected to be occupied by the user,
providing to the user an image representing the floor plan of the space,
providing to the user various improvement options,
receiving input concerning improvement options for the space selected by the user,
providing to the user an image representing the space implemented with the improvement options, and
handling a transaction between the user and the service provider in which the user engages the service provider to remodel the space in accordance with the selected improvement options.

15. An interactive system for facilitating customization of the layout of a space to be occupied by a user, comprising:
server means configured to store:
physical attributes of the space predetermined by the service provider independent of the user's input, and
various improvement options;
client means configured to display:
an image representing the floor plan of the space,
various improvement options, and
an image representing the space implemented with the improvement options;
wherein the client means is further configured to permit the user to:
identify to the server means the space selected to be occupied by the user, and
select improvement options for the space; and
wherein the server is further configured to handle a transaction between the user and the service provider in which the user engages the service provider to remodel the space in accordance with the selected improvement options.

16. A system as in claim 15, wherein the server and the client are coupled over the Internet.

17. A service provided by a service provider for facilitating customization of the layout of a space to be occupied by a user, comprising the steps of:
the service provider predetermining the physical attributes of the space independent of the user's input;
the user identifying to the service provider the space selected to be occupied by the user;
the service provider displaying to the user an image representing the floor plan of the space;
the service provider making available to the user different improvement options that user may select to configure the layout of the space;
the user selecting the improvement options for the space;
the service provider displaying to the user an image representing the space implemented with the improvement options;
the user engaging the service provider to remodel the space in accordance with the selected improvement options; and
the service provider remodeling the space in accordance with the selected improvement options.

18. A dormitory housing service, comprising the steps of:
offering a tenant an opportunity to customize the layout of a dorm room to be occupied by the tenant; and
performing services to customize the dorm room prior to tenant's move in.

19. A dormitory housing service as in claim 18, wherein the step of offering comprises the steps of:
displaying to the tenant an image representing the floor plan of the dorm room;
making available to the tenant different improvement options that tenant may select to configure the layout of the dorm room;
displaying to the tenant an image representing the dorm room implemented with the selected improvement options;
remodeling the dorm room in accordance with the selected improvement options.
